(19) United States
(12) Patent Application Publication
(10) Pub. No.: US 2008/0034132 A1
(43) Pub. Date: Feb. 7, 2008

(54) MEMORY INTERFACE FOR CONTROLLING BURST MEMORY ACCESS, AND METHOD FOR CONTROLLING THE SAME

(75) Inventor: Yuichi Nakatake, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kanagawa (JP)

(21) Appl. No.: 11/831,391

(22) Filed: Jul. 31, 2007

(30) Foreign Application Priority Data
Aug. 1, 2006 (JP) 2006-209765

(51) Int. Cl. G06F 13/00

(52) U.S. Cl. 710/35

(57) ABSTRACT

An access control method and a memory interface which enable access without a redundant bus cycle even to a burst memory having an addressing function different from the system side. A state machine is provided so that addressing mode information of a memory is read from a system internal register, and if burst access is performed at a system address by a predetermined addressing scheme of a bus master, when the addressing scheme of the memory internal address differs from a predetermined addressing scheme of the bus master, at an address transition position where there is a mismatch between the memory internal address and the system address, burst access is first terminated, burst transfer is resumed from an aligned address, and the remaining data are then accessed.

### BACKGROUND OF THE INVENTION

### Field of the Invention

This invention relates to a memory interface and its control method, and in particular to a memory interface and control method for controlling burst memory access.

In semiconductor devices including CPU, in recent years, in response to improvement in CPU speed and increasing complexity, memories which can perform higher speed burst access on a large scale are required, and many kinds of such memories are now being developed.

FIG. 1 is a drawing showing a classic example of a common computer system. Normally, a data processor 1 of FIG. 1 comprises a CPU (Central Processing Unit) 13 and other functional blocks, and is provided with a DMAC (DMA controller) 14 which controls DMA transfer, a memory interface circuit 12, and the like.

The memory interface circuit 12 is connected with the CPU 13 via an internal bus (an internal address bus and internal data bus), and normally comprises a state machine 10 which controls an access cycle and a bus interface 11. The state machine of the invention, described later, may also be installed in the memory interface circuit 12 of FIG. 1.

FIG. 2 shows a memory interface circuit disclosed by JP-A No. HEI8(1996)-77098. This memory interface circuit is used for the general computer system shown in FIG. 1. The essential feature of the construction of FIG. 2 is the state machine 10.

The state machine 10 of FIG. 2 receives information on port size, I-TYPE (burst transfer conditions), and an ACK_EN (enabling of TA and AACK, described later), from a system internal register (not shown) built into the memory interface.

The state machine 10 of FIG. 2 receives an AACK (address acknowledgement) signal and TA (transfer acknowledgement) signal from an external memory (memory 21, 22 of FIG. 1).

This state machine 10 receives control signals including a cache filling request signal from the CPU (13 of FIG. 1).

The state machine 10 receives a control signal including a DMA request signal and a BDIPD signal (DMA burst data in progress) from a DMA controller (14 of FIG. 1).

The state machine 10 has output signals comprising TS (transfer start), BURST (burst cycle), FIX (fixed burst access) and BDIP (burst data in progress)/LAST (showing the last beat of a burst).

The state machine 10 of FIG. 2 is a classic in-series logical state machine, and as shown by the timing charts of FIG. 3 (fixed burst mode) or FIG. 4 (variable burst mode), the signals TS, BURST, FIX, BDIP/LAST, are controlled by the state machine 10. FIG. 3 and FIG. 4 correspond to FIG. 2 and FIG. 3 of JP-A No. HEI8(1996)-77098, and since the details are described in relation to JP-A No. HEI8(1996)-77098, they will therefore be omitted here.

FIG. 5 is a diagram for describing the operation of the prior art state machine shown in FIG. 2. The prior art state machine receives a burst transfer command and address data from the bus master (CPU, DMAC, etc.), and also receives memory information, bus size and information as to whether burst is possible/not possible stored in the system internal register. Information about the burst command type, start (head) address and bus bit size is included in the burst transfer command.

Since this state machine is a classic series logical state machine, it shifts to an idle state when there is no transfer.

If the transfer command issued from the bus master is a single transfer, it shifts to the single state of FIG. 5.

The transfer command issued from the bus master is a burst transfer, but also when the memory to be accessed prohibits burst, it shifts to the single state and burst transfer is performed in smaller units as plural single transfers.

On the other hand, when the memory to be accessed allows burst, if the port size of the memory is 32 bits, it shifts to the 32-bit bus burst state of FIG. 5. In this case, burst transfer is performed for the requested number of words of data.

When the memory to be accessed allows burst, if the port size of the memory is 16 bits, it shifts to the 16-bit bus burst state of FIG. 5. In this case, it is first determined by a burst splitting determining state whether a start address is a double word boundary or a word boundary. For example, for addressing in word units, if the least significant bit of the start address is “0”, it is a double word boundary. For addressing in byte units, if the two least significant bits of the start address is “00”, it is a double word boundary.

In the case of a double word boundary address, it shifts to the burst 4 state (16 bits×4) of FIG. 5, and transfer will be repeated 2n (n is an integer equal to 1 or more) times.

On the other hand, in the case of a word boundary address, to perform transfer of one word of data, it shifts to the burst 2 state (16 bits×2) of FIG. 5, then it shifts to burst 4, and transfer in a double word boundary is performed plural times. In order to perform fractional processing of the remaining one word of data, it shifts to the burst 2 state, and one word of data is transferred which terminates the transfer sequence.

Summarizing, the transfer beats (cycles) in 4-word transfer are as follows.

If it is a 32-bit bus, 4 beats×1;

if it is a 16-bit bus and double word boundary address, 4 beats×2;

if it is a 16-bit bus and word boundary address, 2 beats×1, 4 beats×1, and 2 beats×1.

As is well known in the art, various types of memory have recently come into use in semiconductor devices. For example, focusing on the internal addressing function of the burst memory, there are also memories which respond in only one of two states, i.e., an incremental addressing or a wrapping addressing state.

Incremental addressing means that the memory internal address counter always operates in ascending order.

Wrapping addressing means a repeat operation (lap) wherein, if a memory internal address counter counts to a set maximum, it returns again to the address 0.

In a burst transfer command in a system, either one of these addressing commands may be issued depending on the system.

JP-A No. HEI5(1993)-101644 discloses a wraparound counter circuit (while both RAS* and CAS* are LOW level, inputs a LOW level clock CK) which uses an arbitrary value of plural bits as a preset value, performs a wraparound calculation in synchronism with an internal access cycle, sequentially updates the preset value and outputs it, having a wraparound access mode which replaces an address bit output from the wraparound counter circuit by an address bit from an address latch, supplies it to a column address decoder, and selects memory cells having continuous plural addresses from an arbitrary position by wraparound.

JP-A No. 2003-509803 discloses that, when a wrap bit is set, a burst reader latches a current data page, adjusts a word pointer showing a following data word, and then latches/adjusts it in a non-sequential burst reading sequence.

### SUMMARY

The prior art state machine 10 formed in the memory interface 12 does not take account of the addressing function on the memory side. The memory side may also for example assume wrapping operation, and not take account of the addressing function on the system side. In other words, neither the case of a fixed-length burst transfer of only an increment to a memory which cannot perform address wrapping, nor conversely the problems arising when there is a fixed-length burst transfer to a memory which can perform only address wrapping, are taken into consideration. Therefore, a mismatch of the addressing function occurs between the system and memory sides.

Here, the reason for the problems which may occur during transfer to a state machine of the prior art will be described (based on a study carried out by the Inventor).

First, regarding a 32-bit 4 word fixed-length burst transfer to a memory (only incremental) which cannot perform address wrapping, when the start address is not aligned with the double word boundary, as shown in FIG. 7(A), the system address (address expected on the data processor side) shifts as in A2->A3->A0->A1 (since the addressing function on the data processor side is wrapping), but the memory internal address will be incremented as in A2->A3->A4->A5 (since the addressing function on the memory side is incremental), and two words of invalid data (invalid data D4, D5) will be read.

In the case of an 8 word fixed-length burst transfer, as shown in FIG. 7 (B), 6 words of invalid data (invalid data D8-D13) will be read.

On the other hand, in the case where the start address is not aligned with the double word boundary by 32-bit 4 word fixed-length burst transfer to a memory (only wrapping) which cannot perform address incrementing, as shown in FIG. 8 (A), the system address becomes A2->A3->A4->A5 (since the addressing function on the system side is incremental), but the memory internal address will wrap like A2->A3->A0->A1, and two words of invalid data will be read, Likewise, in the case of an 8 word fixed-length burst transfer, as shown in FIG. 8(B), 6 words of invalid data will be read.

If the system is aware that there is invalid read-out data beforehand, it can respond by making a second access from the address which became invalid by software, but the transfer cycle of the first invalid data will be wasted.

In this case, if suitable management is not performed by software, in the worst case, a system abort may occur.

In the present invention, a state machine also performs a conditional determination about the addressing function of the memory.

A method according to a first aspect of the invention is a burst access control method for controlling burst memory access between a bus master and a memory by a memory interface, and the method includes the steps of:

when burst access is performed at a system address in a first addressing mode from the bus master, when the addressing scheme of a memory internal address is a second addressing mode different from the first addressing mode,

splitting burst transfer in a first cycle where there is a mismatch between the system address and memory internal address due to difference of addressing scheme so as to align the system address with the memory internal address, and after aligning the system address and memory internal address, resuming burst transfer and accessing remaining data.

According to an embodiment of the invention, even when a burst memory has a different addressing function on the memory side and system side, since a memory controller splits the burst access command issued on the system side and supplies it to the memory, access may be performed without a redundant bus cycle. As a result, efficient burst transfer can be realized.

Since a redundant bus cycle can be eliminated even when the addressing function is different on the system side and memory side, there is no need to be concerned about burst memory addressing which can be used with semiconductor devices including CPU, memories can be used with a wider selection of data processors, and product flexibility can be further improved.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows an ordinary computer system;

FIG. 2 shows a memory interface circuit of a prior art example;

FIG. 3 shows a timing operation of fixed-length burst access in a prior art example;

FIG. 4 shows a timing operation of variable burst access in a prior art example;

FIG. 5 describes a state machine of a prior art example;

FIG. 6 describes the state machine of the present invention;

FIG. 7 shows a burst transfer read operation example 1 according to a prior art example (when wrapping addressing access is performed from a CPU to an incremental addressing memory);

FIG. 8 shows a burst transfer read operation example 2 according to a prior art example (when incremental addressing access is performed from a CPU to a wrapping addressing memory);

FIG. 9 shows a burst transfer read operation example 1 according to this embodiment (when wrapping addressing access is performed from a CPU to an incremental addressing memory);

FIG. 10 is a burst transfer read operation example 2 according to this embodiment (when incremental addressing access is performed from a CPU to a wrapping addressing memory); and

FIG. 11 shows one embodiment of the state machine of the invention.

FIG. 12 shows a detailed timing chart of FIG. 7 (A).

FIG. 13 shows a detailed timing chart of FIG. 9 (A).

### DETAILED DESCRIPTION OF THE PREFERRED EMBODIMENTS

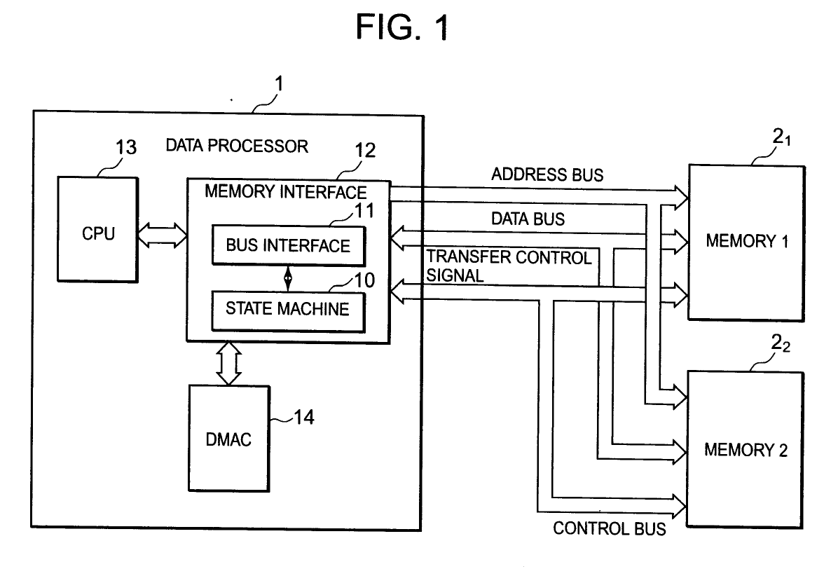

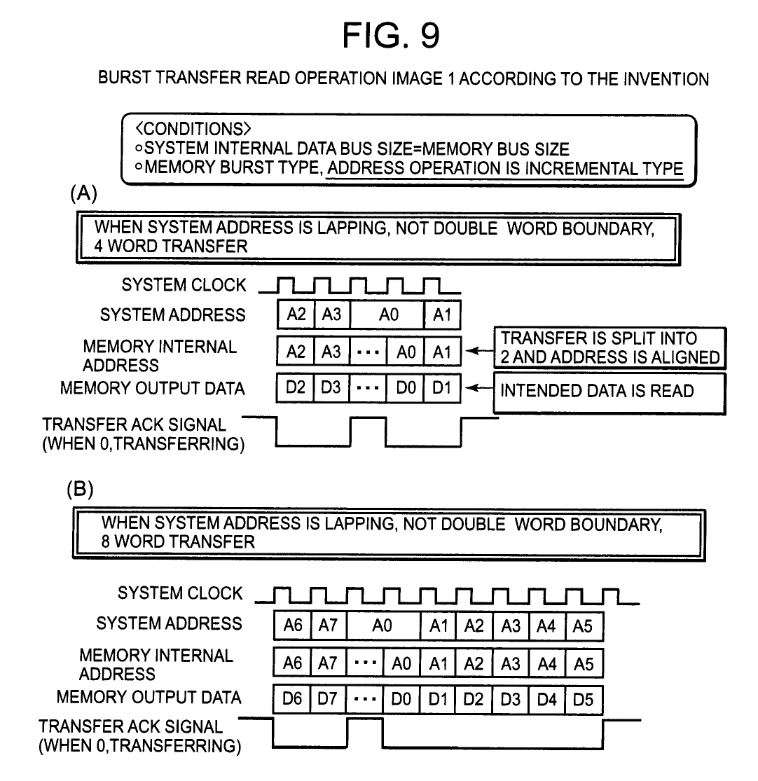

The invention will be now described herein with reference to illustrative embodiments. Those skilled in the art will recognize that many alternative embodiments can be accomplished using the teachings of the present invention and that the invention is not limited to the embodiments illustrated for explanatory purposes. The invention will now be described in further detail referring to the accompanying drawings. The method of the invention relates to a burst memory access control between a bus master (CPU 13 or DMAC 14) and memories 21, 22, by a memory interface (12 in FIG. 1). Control is performed so that, when burst access is performed at a system address by a wrapping addressing scheme from the bus master to a memory which generates a memory internal address by an incremental addressing scheme, at an address transition position where there is a mismatch between the memory internal address and the system address due to difference of addressing scheme, after terminating burst access, the system address is aligned with the memory internal address (for example, the memory internal address A0 of FIG. 9(A), FIG. 9(B)), burst transfer is resumed from the aligned address and the remaining words of data are then accessed.

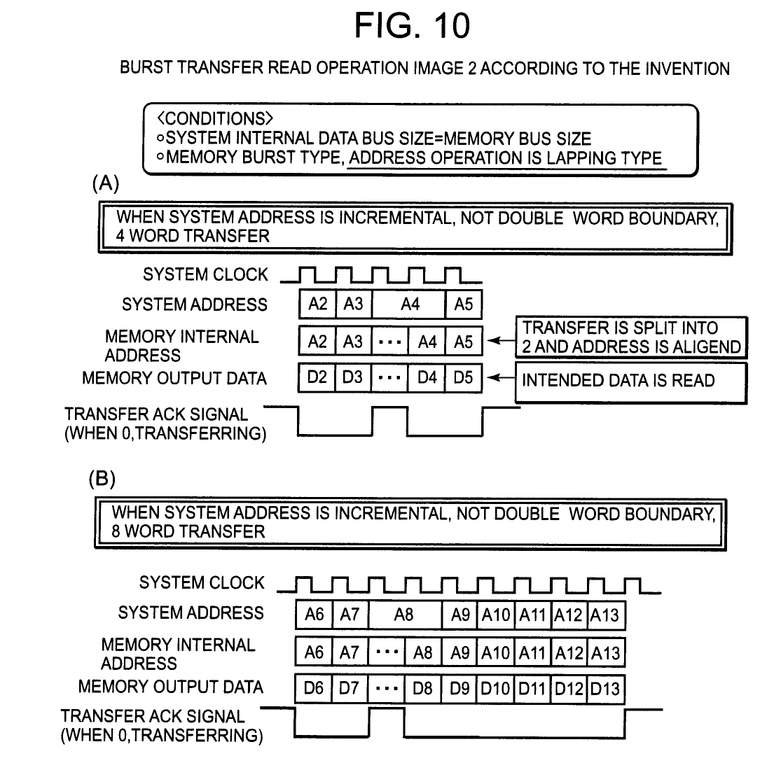

The method according to the invention relates to a burst memory access control between a bus master (CPU or DMAC) and a memory by a memory interface (12 in FIG. 1). Control is performed so that, when a burst access is performed at a system address by an incremental addressing scheme from the bus master to a memory which generates a memory internal address by a wrapping addressing scheme, at an address transition position where there is a mismatch between the memory internal address and the system address due to difference of addressing scheme, after terminating burst access, the system address is aligned with the memory internal address (for example, the memory internal address A4 of FIG. 10(A), or the memory internal address A8 of FIG. 10(B)), burst transfer is resumed from the aligned address and the remaining words of data are then accessed.

Specifically, the memory interface 12 splits a burst access command received from the bus master (CPU 13 or DMAC 14) at a position where an address shift mismatch due to the memory addressing scheme and bus master addressing scheme is detected, and differences in the addressing scheme are absorbed by splitting the burst access command from the bus master into plural burst access commands.

Hereafter, this will be described in detail referring to specific embodiments.

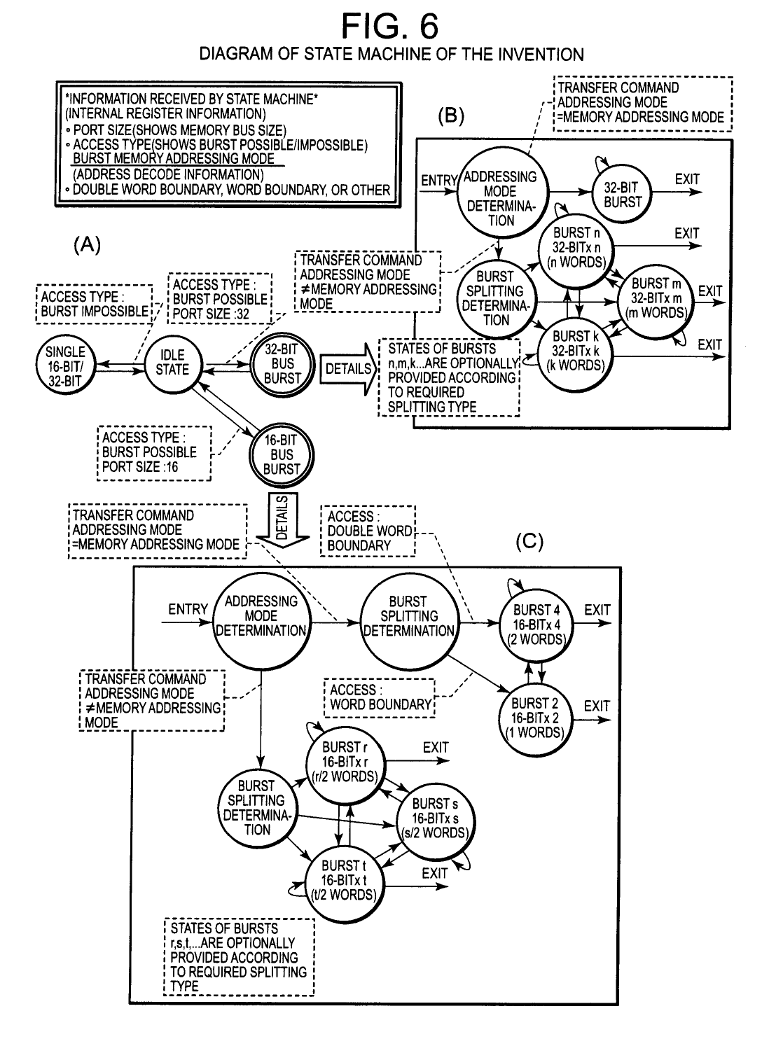

FIG. 6 describes a state machine of one embodiment of this invention. Although not particularly limited, the state machine of the invention will be described in the case where it has been installed in the memory interface 12 shown in FIG. 1.

The state machine of this example is different from that of the aforesaid prior art in that addressing mode information (incremental or wrapping) on the memory side is acquired from the system internal register.

First, it shall be assumed that the state machine is in the idle state, and that it is waiting for a burst access command from the bus master.

If, when it is in the idle state, the burst access command (burst transfer command) issued from the bus master is a single transfer, it will shift to the single state (single 16 bit/32 bits) of FIG. 6. Even if the transfer command issued from the bus master is a burst transfer and the memory to be accessed prohibits burst, it shifts to the single state and splits the burst transfer into plural single transfers.

When the memory can be accessed by burst, in the case of a burst transfer, the bus size is read from information in the system internal register, and it shifts from the idle state to a 32-bit bus burst or 16-bit bus burst state.

Next, the case will be described where the addressing scheme (addressing mode) on the memory side is read from information in the system internal register, and if it is different from the addressing mode on the system side, it shifts to a burst splitting determining state.

Here, the transfer splitting frequency and rate, for example in the case of 8 words, whether it is split 2-6 (split into 2, 2 words and 6 words), or 1-6-1 (split into 3, 1 word, 6 words and 1 word), are determined depending on the start address alignment position, the transfer command type (wrapping burst or incremental burst), and addressing mode type on the memory side.

Regarding specific conditions, it is assumed that suitable optimization is performed according to the specification of the burst memory to be used. As an example, in the case of a 32-bit bus, splitting into n+m+k . . . (where, n, m, k are integers) is performed.

Likewise, in the case of a 16-bit bus, splitting into r+s+t . . . (where, r, s, t are powers of 2), but since the bus width is ½ that of a 32-bit bus, the transfer frequency is simply twice that of 32-bits.

FIG. 9 and FIG. 10 respectively show burst transfer read operation examples 1, 2 in this embodiment, and have the purpose of describing the operation when a burst read transfer command is issued from a bus master, to a memory compliant with incremental addressing and a memory compliant with wrapping addressing.

FIG. 9 shows an example of the timing operation when burst read access was performed at a wrapping address from a bus master, to an incremental addressing memory.

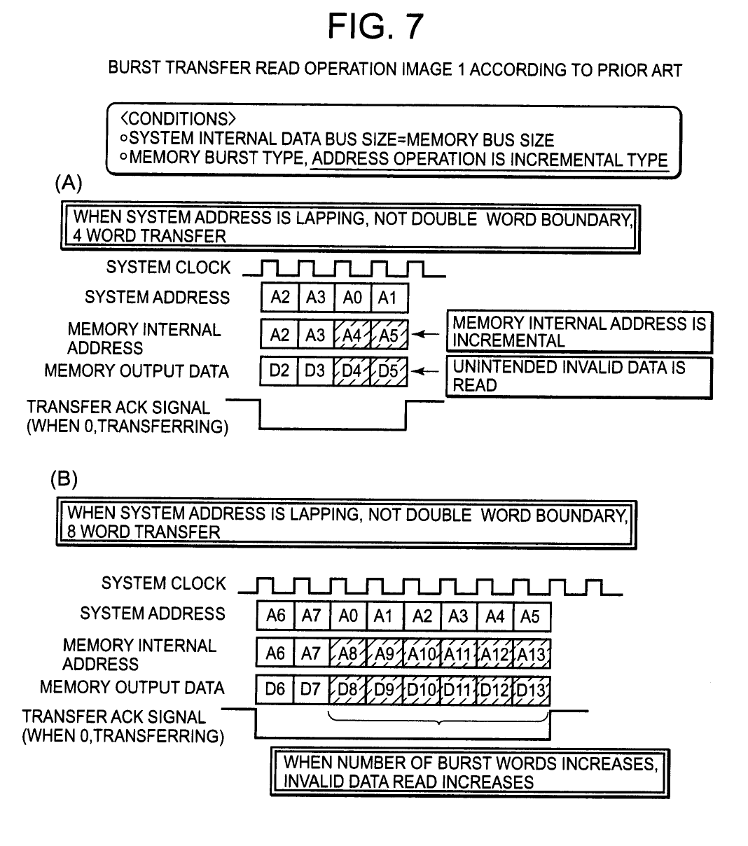

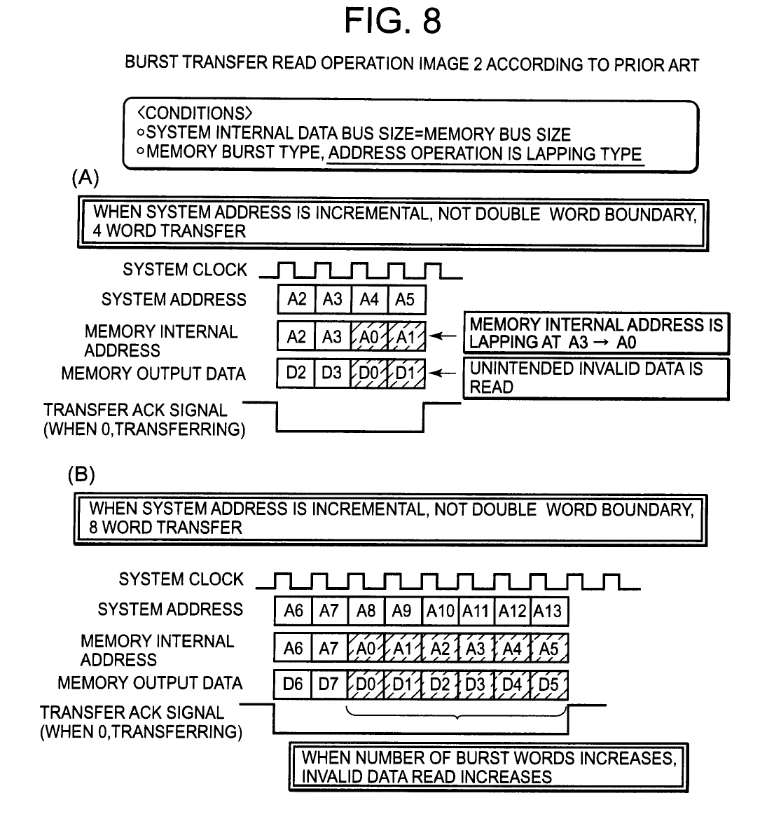

As shown in FIG. 9(A), in a 4 word burst transfer in the case of the addresses A2->A3->A0->A1, with a prior art state machine, a mismatch occurs as shown in FIG. 7 (A), but in this embodiment, burst read access is first terminated at the address transition position A3->A0, burst transfer is resumed from the address A0, and the remaining 2 words of data (A0 and A1) are read.

In other words, the memory interface 12 comprising the state machine 10 splits the 4 word burst transfer command starting from A2 outputted from the bus master in to a 2 word burst transfer command starting from A2, and a 2 word burst transfer command starting from A0, and supplies them to the memory.

Specifically, the memory interface (12 of FIG. 1) receives an ACK signal TA from the memory at the address transition position A3->A0, and terminates burst access of 4 words starting from A2. When the memory interface (12 of FIG. 1) receives this acknowledgement, it recognizes that transfer was interrupted at address A3 based on the burst read length and the word length already read, and burst read access of the 2 remaining words of data is resumed from the address A0 (a 2 word burst transfer command starting from A0 is issued). Also, the memory internal address on the memory side is aligned with the system address A0.

On the memory side, in FIG. 9(A), a read operation is not performed in one clock cycle between the memory internal address A3, the system address A0 and the address A0 for which address alignment was performed.

This means that, regarding the system address, after the address A3, a read operation was apparently performed for 2 cycles at the address A0, and data DO at the address A0 is read in the next cycle. In order to terminate burst access at the cycle of an address transition position, the signal which the memory interface receives from the memory may be a ready signal or the like showing the completion of transfer.

Likewise, in an 8 word burst transfer, in the case of the addresses A6->A7->A0->A1->A2->A3->A4->A5, with the prior art state transfer, an address transition position mismatch occurs at A7->A0 as shown in FIG. 7 (B), but in this embodiment, after reading 2 words (A6, A7), the memory sends an ACK signal TA to the memory interface, burst access is first terminated (the bus master can see that this is WAIT), burst transfer is resumed from the address A0, and the remaining 6 words of data are read. In other words, the memory interface splits the 8 word burst transfer command starting from A6 outputted from the bus master, into a 2 word burst transfer command starting from A6, and a 6 word burst transfer command starting from A0, and outputs them.

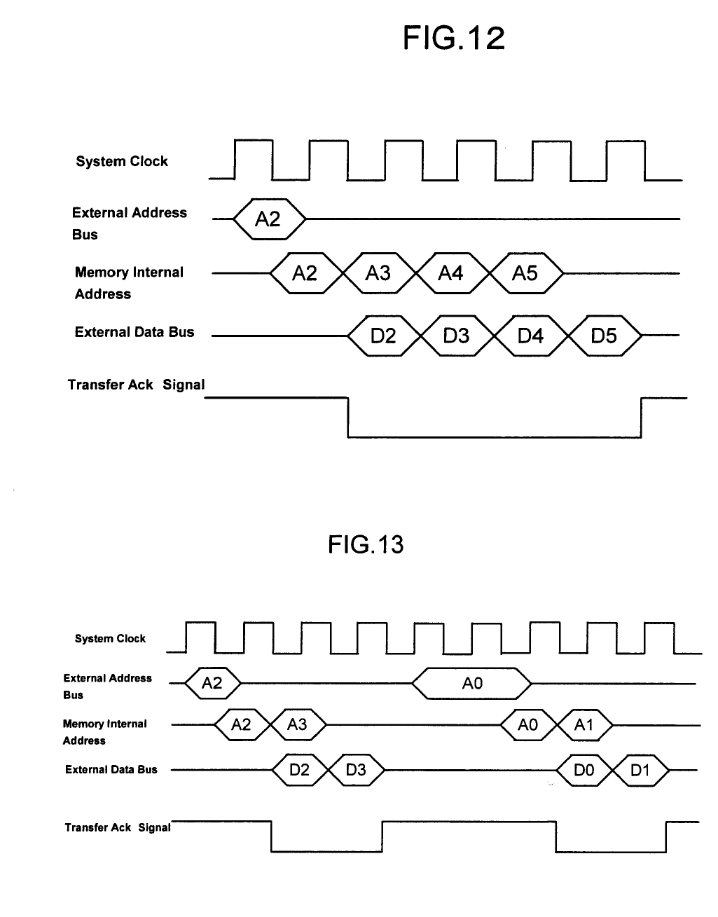

Hence, valid data at addresses requested by the bus master can all be read by one burst transfer command from the bus master. FIG. 12 shows the detailed timing chart with respect to the timing chart of FIG. 7 (A). FIG. 13 shows the detailed timing chart with respect to the timing chart of FIG. 9 (A). Referring to the FIG. 13 (A), in this embodiment, two burst start addresses are outputted onto the external address bus relative to a burst transfer request. For example, in FIG. 13 (A) a burst start address A2 is outputted onto the external bus. Next, a burst star address A0 is outputted onto the external bus.

Next, the operation when a burst read access to a wrapping addressing memory is performed at an incremental address by the bus master, will be described.

Referring to FIG. 10 (A), in a 4 word burst transfer starting from A2, in the case of the addresses A2->A3->A4->A5, in the prior art, an address mismatch occurs at the address transition position A3->A4. However, in this embodiment, after reading 2 words (A2, A3), burst access is once terminated (the bus master can see that this is WAIT), burst transfer is resumed from the address A4, and the remaining 2 words of data are read. At the address transition position A3->A4, the memory interface (12 of FIG. 1) receives an ACK signal TA from the memory, and terminates the first burst access. The memory interface (12 of FIG. 1), when it receives this acknowledgement TA from the memory. resumes burst read access of the 2 remaining words of data from the address A4 based on the burst read length and the word length already read. Specifically, the 4 word burst transfer command starting from A2 outputted from the bus master is split by the memory interface into a 2 word burst transfer command starting from A2, and a 2 word burst transfer command starting from A4, and is outputted to the memory. On the memory side, in FIG. 10(A), a read operation is not performed in one clock cycle between the memory internal addresses A3, A4. This means that regarding the system address, a read operation is apparently performed for 2 cycles at the address A4 after the address A3, and data D4 is read from the address A4 in the next cycle.

Likewise, referring to FIG. 10(B), in an 8 word burst transfer, in the case of the addresses A6->A7->A8->A9->A10->A11->A12->A13, a mismatch occurs at the address transition position A7->A8, but after reading 2 words (A6, A7), burst access is first terminated, then burst transfer is resumed from the address A8, and the remaining 6 words of data are read. Specifically, the 8 word burst transfer command having the starting address A6 outputted from the bus master, is split by the memory interface into a 2 word burst transfer command having the starting address A6, and a 6 word burst transfer command having the starting address A8, and supplied to the memory. Hence, valid data at the address requested by the bus master, can all be read by one burst transfer command outputted from the bus master.

A transfer control signal in the above transfer operation is arbitrarily set according to the specification of the system to which the invention is applied.

In a data system which performs general burst memory access, even when the memory side cannot respond functionally to the request address of the bus master, if the memory interface is provided with the state machine of the present invention, a burst access cycle can be split according to the burst start address value and the addressing function on the memory side, so access can be performed without a redundant transfer cycle.

In the state machine of the invention, if an internal register which always sets an addressing mode determination as fixed is provided, it can function also as a state machine identical to that of the prior art. Hence, it can be connected as a system even to a burst memory which does not require an addressing mode determination.

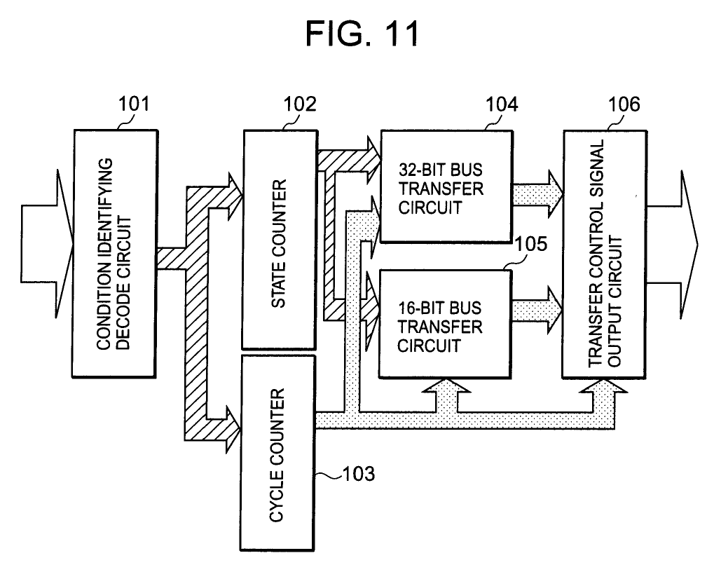

FIG. 11 is a drawing showing one embodiment of the state machine of the invention. The state machine is provided with a condition identifying decode circuit 101, state counter 102, cycle counter 103, 32-bit bus transfer circuit 104, 16-bit bus transfer circuit 105, and transfer control signal output circuit 106. These elements essentially operate as follows.

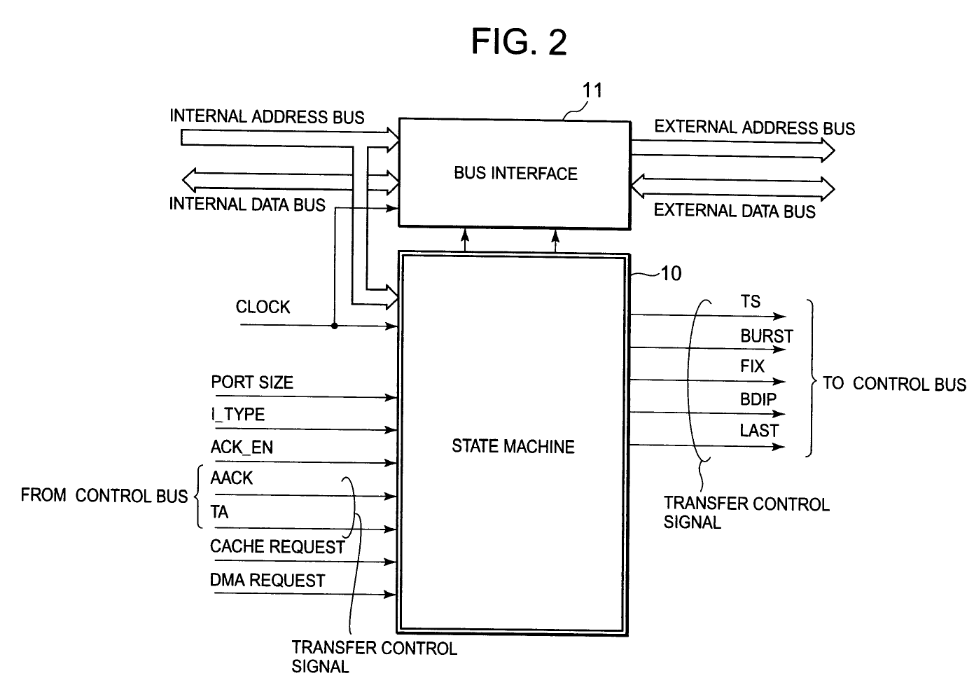

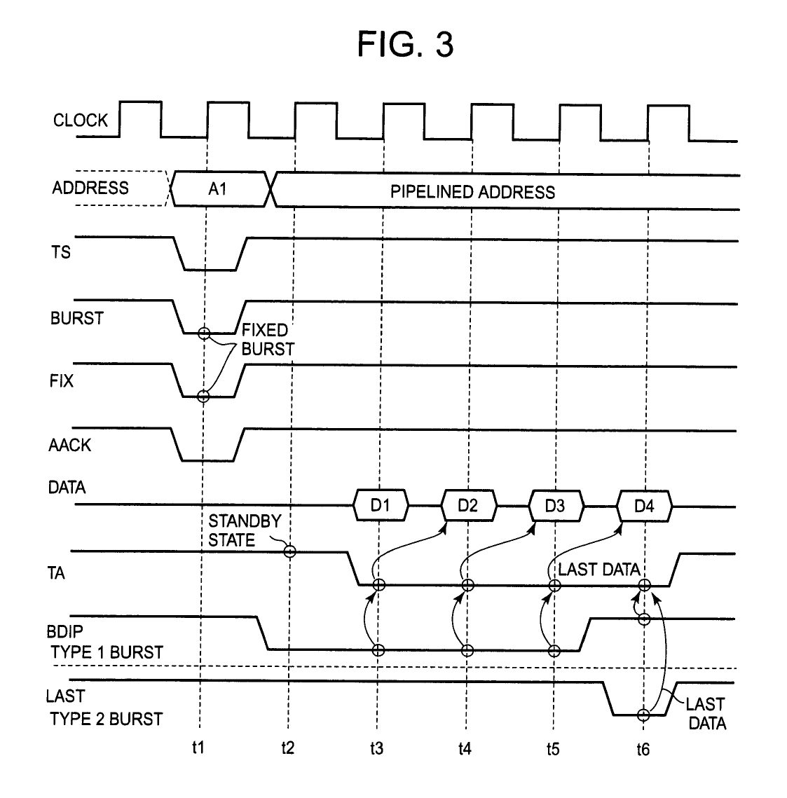

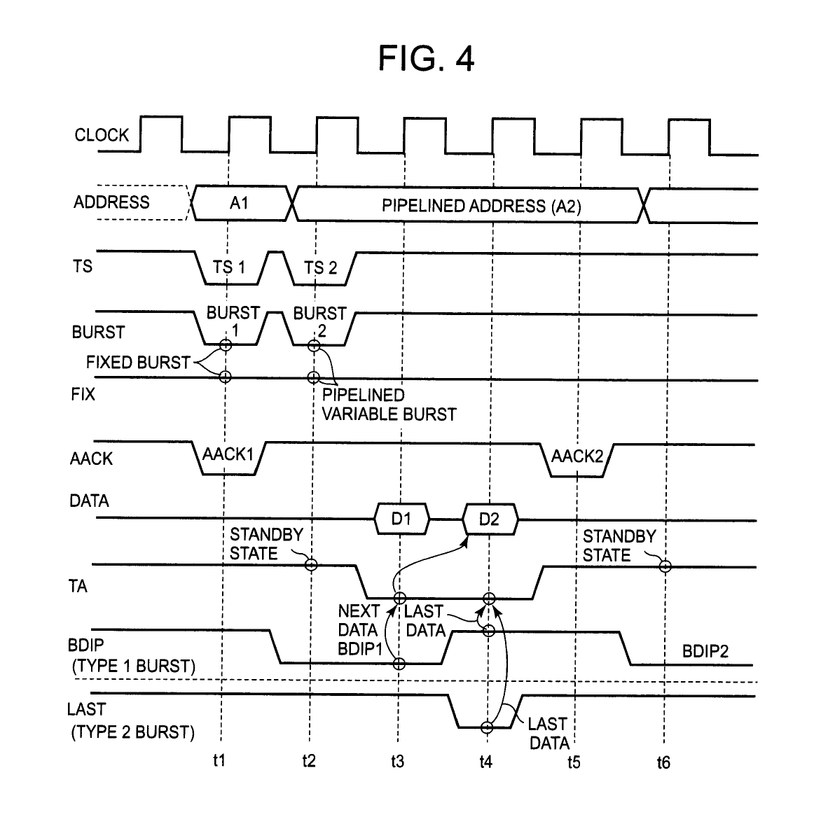

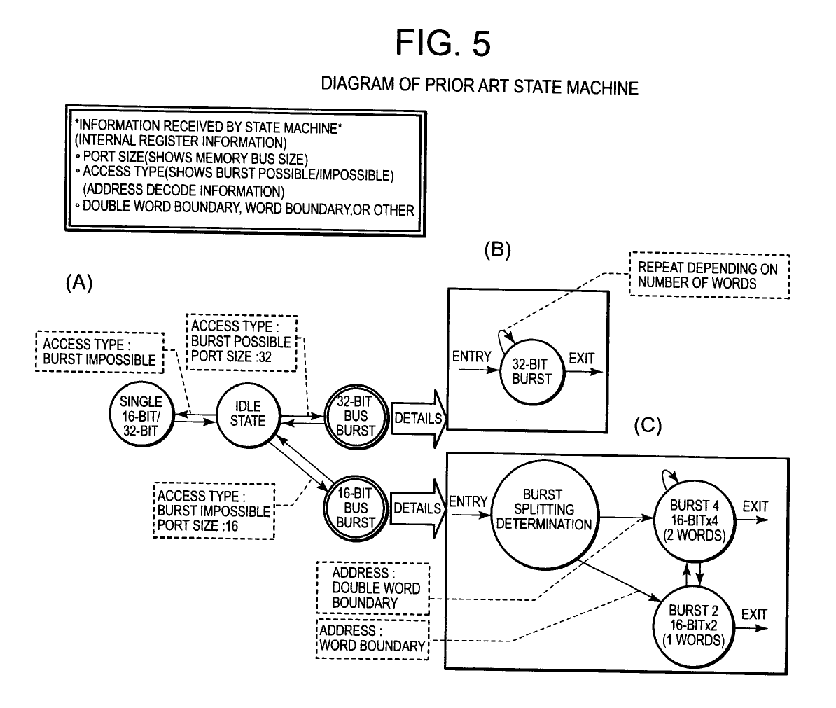

The condition identifying decode circuit 101, as described referring to FIG. 2, receives register information (addressing mode of the memory) from the system internal register (not shown), transfer request contents from bus masters such as a CPU or DMAC, and a transfer ACK (TA) from the memory, decodes them, generates a transfer information decoded signal, and supplies it to the state counter 102 and cycle counter 103. Although not particularly limited, the condition identifying decode circuit 101 generates a transfer information decoded signal in the idle state of FIG. 6, and the generated transfer information decoded signal is inputted to the state counter 102 and cycle counter 103.

In the state counter 102, shifting state information in the state machine (state transition diagram of FIG. 6), is converted to a counter value and outputted. In the cycle counter 103, a number of transfer cycles is counted.

Based on the values of the state counter 102 and cycle counter 103, an enable/disable timing of a control signal is determined by the 32-bit bus transfer circuit 104 or 16-bit bus transfer circuit 105. Based on enable/disable of the control signal from the 32-bit bus transfer circuit 104 or 16-bit bus transfer circuit 105, the transfer control signal output circuit 106 outputs control signals (transfer start, transfer stop, etc.).

The condition identifying decode circuit 101 reads the addressing mode on the memory side from the information in the system internal register, and when it is different from the addressing mode on the system side, it shifts to the burst splitting determining state, and performs control to shift to the burst splitting determining state. The state counter 102, cycle counter 103, 32-bit bus transfer circuit 104 or 16-bit bus transfer circuit 105, controls the splitting frequency and rate such as 32 bit×k, 32 bit×m, 32 bit×n (FIG. 6(A)), and the splitting frequency and rate such as 16 bit×r, 16 bit×s, 16 bit×t (FIG. 6(B)).

In the invention, redundant bus cycles during burst memory access can be eliminated, the choice of burst memory which can be used with semiconductor devices including CPU is widened, and product flexibility is enhanced.

In the aforesaid embodiment, a read burst operation was described as an example, but the same is true of a write burst operation. In the aforesaid embodiment, information about the addressing mode was written beforehand in the system internal register, but the user may write information based on the memory addressing scheme in the system internal register when the memory is connected, or if data showing the addressing mode is written in the memory when the memory is connected, this data may be read, and the addressing scheme determined based on this data with or without writing it in the system internal register.

The invention has been described with reference to specific embodiments, but it will be understood that the invention is not to be construed as being limited in anyway thereby, various modifications and corrections being possible within the scope and spirit of the appended claims. It is apparent that the present invention is not limited to the above embodiments, but may be modified and changed without departing from the scope and spirit of the invention.

What is claimed is:

1. A memory interface comprising:
a bus interface receiving a burst transfer instruction output from a bus master for performing burst transfer with a memory, and outputting a first burst transfer instruction to said memory;
a state machine generating said first burst transfer instruction based on said burst transfer instruction and addressing modes of said bus master and said memory when said addressing modes of said bus master and said memory are different.

2. The memory interface according to claim 1, wherein said state machine sets a start address and a number of times of said first burst transfer instruction based on said burst transfer instruction from said bus master and said addressing modes of said bus masters and said memory.

3. The memory interface according to claim 1, wherein said first burst transfer instruction includes a plurality of burst transfer instructions which said state machine divides said burst transfer instruction thereinto.

4. The memory interface according to claim 3, wherein said state machine receives a control signal which said memory outputs when burst transfer based on one of said plurality of burst transfer instructions is finished, and said bus interface outputs a burst transfer instruction for performing next burst transfer of said finished burst transfer as said first burst transfer instruction in response to said control signal.

5. The memory interface according to claim 3, wherein said state machine divides said burst transfer instruction into said plurality of burst transfer instructions as said first burst transfer instruction based on a difference of said addressing modes of said bus master and said memory and at least any one of a number of times of burst transfer which said burst transfer instruction instructs, a difference of data width of said bus master and said memory and whether a start address of burst transfer which said burst transfer instruction instructs is predetermined word boundary or not.

6. The memory interface according to claim 1, further comprising:
a register memorizing information indicating said addressing mode of said memory.

7. The memory interface according to claim 3, wherein each of start addresses which each of said plurality of burst transfer instructions instructs is different.

8. A data processor comprising:
a bus master unit coupled to an internal bus and issuing a burst transfer request which requires a plurality of data with respect to a burst start address; and
a memory interface unit coupled between the internal bus and an external bus and performing a burst transfer operation in response to the burst transfer request;
the burst transfer operation being performed in a first mode by transferring the plurality of data between the internal and external buses with the memory interface unit issuing first burst address information relative to the burst start address onto the external bus and in a second mode by transferring the plurality of data between the internal and external buses with the memory interface unit issuing the first burst address information relative to the burst start address and the second burst address information onto the external bus.

9. The data processor as claimed in claim 8, wherein the burst transfer operation is performed on a memory coupled to the external bus and the burst transfer operation according to the second mode is performed when an addressing mode designated by the burst transfer request is different from an addressing mode supported by the memory.

10. The data processor as claimed in claim 8, wherein a first predetermined number of data of the plurality of data appear on the external bus in response to the first burst address information and a second predetermined number of data of the plurality of data appear on the external bus in response to the second burst address information.

11. The data processor as claimed in claim 10, wherein each of the first and second predetermined number is plural.

12. The data processor as claimed in claim 8, wherein the memory interface unit includes a state machine unit storing an addressing mode supported by a resource coupled to the external bus, one of the first and second mode being selected and the burst transfer operation according to a selected one of the first and second modes is performed in response to the addressing mode and the burst transfer request.

13. The data processor as claimed in claim 8, wherein in the first mode at least four data are transferred between the internal and external buses in response to the first burst address information and in the second mode at least one of the four data is transferred between the internal and external buses in response to the first burst address information and the remaining one or ones of the four data are then transferred between the internal and external buses in response to the second address information.

14. A method of performing a burst transfer operation, comprising:
issuing a burst transfer request which requires a plurality of data with respective of a burst start address;
selecting one of first and second burst transfer modes in response to the burst transfer request;
transferring the plurality of data between internal and external buses by issuing first address information relative to the bust start address when the first burst transfer mode is selected; and
transferring the plurality of data between the internal and external buses by issuing first address information and second address information different from the first address information when the second burst transfer mode is selected.

15. The method as claimed in claim 14, wherein the number of the plurality of data is equal to a sum of the number of data transferred in response to the first address information and the number of data transferred in response to the second address information.

16. The method as claimed in claim 14, further comprising generating a control signal between issuance of the first address information and issuance of the second address information.

17. The method as claimed in claim 14, further comprising storing an addressing mode of a resource subject to the burst transfer request, one of the first and second modes being selected in response to the addressing mode and the burst transfer request.
